(19) United States
(12) Patent Application Publication
(10) Pub. No.: US 2026/0228316 A1
(43) Pub. Date: Aug. 6, 2026

(54) VIRTUAL REALITY SYSTEM AND HEAD-MOUNTED DISPLAY USED THEREIN

(71) Applicant: Maxell, Ltd., Kyoto (JP)

(72) Inventors: Hitoshi AKIYAMA, Kyoto (JP); Masuo OKU, Kyoto (JP)

(21) Appl. No.: 19/113,438

(22) PCT Filed: Sep. 22, 2022
(86) PCT No.: PCT/JP2022/035329

§ 371 Date: Mar. 20, 2025

(51) Int. Cl. G06F 21/32; G06T 11/00; G09G 3/00

(52) U.S. Cl. CPC G06F 21/32; G06T 11/00; G09G 3/001; G09G 2354/00; G09G 2358/00

(57) ABSTRACT

A virtual reality system includes a server that provides virtual reality services, a head mounted display that receives the virtual reality services, and a network that connects the server and the head mounted display, wherein the server retains first object data for generating a first avatar image for display, second object data for generating a second avatar image for capture, and a capture permission attribute for setting capture conditions when a user is captured by an other user as user information, the server transmits the first object data or the second object data to the head-mounted display according to the capture permission attribute, the head-mounted display generates and displays the first avatar image or the second avatar image from the received first object data or second object data.

### TECHNICAL FIELD

This invention relates to a virtual reality system and a head-mounted display used therein, which provides a capture functionality that considers privacy protection for participants in the virtual reality system.

### BACKGROUND ART

There are virtual reality systems that provide background data and object data in a virtual space to participants (hereinafter referred to as users) who wear a head mounted display (hereinafter referred to as HMD) to experience virtual reality (VR).

In addition, there are two types of virtual reality systems: anonymous virtual reality systems, in which the virtual space is artificial, such as in games, and users use nicknames or avatar images generated using computer graphics (CG); and non-anonymous virtual reality systems, in which the virtual space is an imitation of the real world and users, in principle, use their real names or avatar images that they can associate with themselves. Examples of the latter type of virtual space include: a virtual administrative space in which users can go through procedures that require identification while being guided by an official at a government office; a virtual school space in which students can interact with each other in class or during breaks; a virtual social space that permits users to recognize other people; and a virtual sightseeing space that they can share experience with their peers.

In the real world, with the widespread use of smartphones, camera capturing has become common. However, distributing photos that include individuals who have not consented to being photographed in online spaces poses legal issues, and this provides a certain deterrent effect on privacy protection. In addition, the distribution can be made possible by blurring or mosaicing the areas where individuals who have not consented to have their picture taken are included in the picture.

In the capture functionality in the virtual space of a non-anonymous virtual reality system, the user experiences the system as if they were in the real world. Therefore, privacy protection measures are required for non-anonymous virtual reality systems as well as for the real world.

An example of privacy protection in a virtual reality system is described in Patent Document 1. Patent Document 1 describes detecting a specific situation in which a predetermined specific action of an avatar is detected. This avatar corresponds to a first user placed in a virtual space. This specific action to be hidden from a second user who is different from the first user. When such a specific situation is detected, a content image of the virtual space that hides the specific action from the second user is displayed on the user terminal of the second user.

### CITATION LIST

### Patent Document

Patent Document 1: Patent Publication No. 2021-56884.

### SUMMARY OF THE INVENTION

### Problems to be Solved by the Invention

The purpose of privacy protection in Patent Document 1 is to prevent other users from seeing the user's actions when a specific action to be hidden is performed, such as when a user enters passwords or other protective information. Patent Document 1 is not considered with respect to the capture functionality, which is the subject of the present invention.

The present invention was made in view of the above points, and its purpose is to provide a capture functionality in a virtual space in consideration of privacy protection measures in a non-anonymous virtual reality system.

### Solutions to Problems

The present invention, to give an example, provides a virtual reality system comprising a server that provides virtual reality services, a head mounted display that receives the virtual reality services, and a network that connects the server and the head mounted display, wherein the server retains first object data for generating a first avatar image for display, second object data for generating a second avatar image for capture, and a capture permission attribute for setting capture conditions when a user is captured by an other user as user information, the server transmits the first object data or the second object data to the head-mounted display according to the capture permission attribute, the head-mounted display generates and displays the first avatar image or the second avatar image from the received first object data or second object data.

### Effects of the Invention

According to the present invention, it is possible to provide a capture functionality in a virtual space in a non-anonymous virtual reality system, taking user privacy protection into consideration.

### BRIEF DESCRIPTION OF THE DRAWINGS

FIG. 1 shows a system configuration diagram of the virtual reality system in Example 1.

FIG. 2 shows an external view of the HMD in Example 1.

FIG. 3 shows a functional block diagram of the HMD in Example 1.

FIG. 4 shows a hardware block diagram of the HMD in Example 1.

FIG. 5 shows a sequence diagram between the HMD and the virtual reality service server in Example 1.

FIG. 6 shows a diagram illustrating the virtual space of the HMD and the range of visibility of the user in Example 1.

FIG. 7 shows a display image of the HMD in Example 1, with the capture image superimposed on a part of the display image.

FIG. 8 shows an example of the virtual space to be captured by the HMD in Example 1.

FIG. 9A shows an example of the display of a capture image of the HMD when the use of object data for capture that can identify the person is permitted in Example 1.

FIG. 9B shows an example of the display of a capture image of the HMD when the use of object data for capture that can identify the person is not permitted in Example 1.

FIG. 9C shows an example of the display of a capture image of the HMD when capture is not permitted in Example 1.

FIG. 10 shows a user attribute table managed by the virtual reality service server in Example 1.

FIG. 11 shows a flowchart of the virtual reality processing of the virtual reality service program for the HMD in Example 1.

FIG. 12 shows a sequence diagram between the HMD and the virtual service provision server in Example 2.

FIG. 13 shows a flowchart of the virtual reality processing of the virtual reality service program of the HMD in Example 2.

FIG. 14 shows a flowchart of the virtual reality processing of the virtual reality service program of the HMD in Example 3.

### MODE FOR CARRYING OUT THE INVENTION

The examples of the invention are described below with reference to drawings.

### Example 1

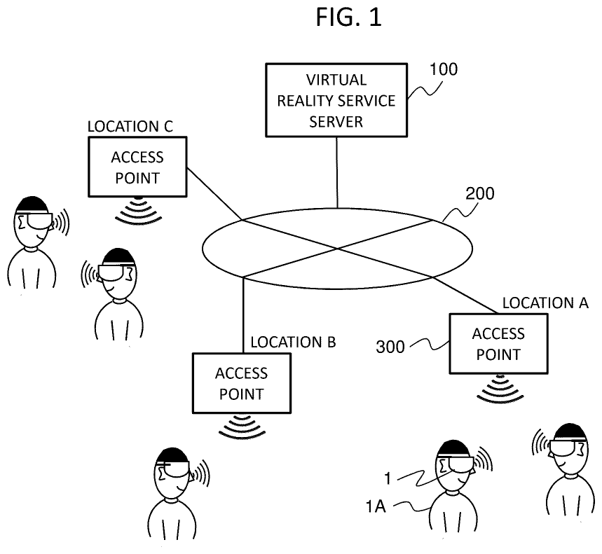

FIG. 1 shows a system configuration of the virtual reality system in this example. In FIGS. 1, 100 is a virtual reality service server (hereinafter referred to as server 100), 200 is a network, 300 is an access point, 1 is the HMD, and 1A is the user. In FIG. 1, access point 300 is located at location A. Other access points are located at locations B and C. The functionality of these access points is equivalent. Users can receive virtual reality services from the virtual reality service server 100 via network 200 at each access point of the different locations. User 1A is at base A wearing HMD 1. Although the reference numerals are abbreviated, there are other users as well, and they can receive the virtual reality service at the same time.

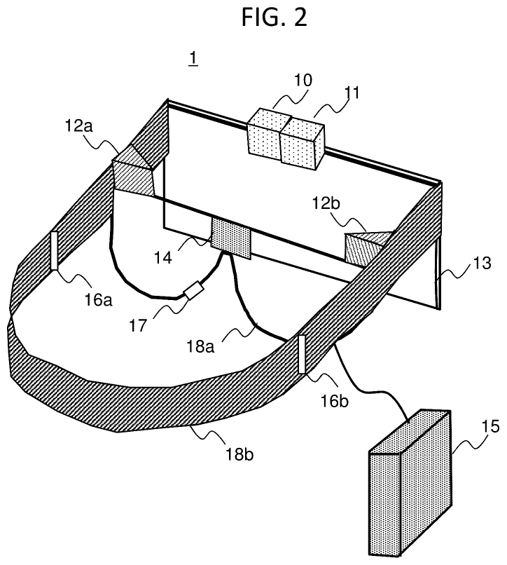

FIG. 2 shows an external view of the HMD in this example. In FIG. 2, HMD 1 has a camera 10, a ranging unit 11, a pair of left and right image projection units 12a, 12b, a screen 13, a group of position and motion sensors 14, a control unit 15, a pair of left and right speakers 16a, 16b, a microphone 17, and mounting sections 18a, 18b.

The user of the HMD 1 (the user of the virtual reality system) attaches the HMD 1 to the user's own head at mounting sections 18a and 18b. Mounting section 18a supports the HMD at the nose of the face and mounting section 18b secures the HMD around the head.

The camera 10 captures images of the front of HMD 1. The control unit 15 captures images from the camera 10 and recognizes real objects and other objects from the images. In addition, the control unit 15 recognizes the real object in three dimensions by adding depth data obtained from the ranging unit 11 to the real object. The control unit 15 also generates a background image generated from the background data of the virtual space and an avatar image generated from the object data as a three-dimensional image of the virtual space that is projected by the projection units 12a and 12b onto the screen 13. The control unit 15 also generates the sound to be amplified by the speakers 16a and 16b.

The projection units 12a and 12b and the screen 13 constitute the display unit of the HMD 1. The image viewed by the left eye for the virtual object is projected onto the screen 13 by the projection unit 12a, and the image viewed by the right eye is projected onto the screen 13 by the projection unit 12b. This generates the illusion that the virtual object appears to be at a predetermined distance in the real world.

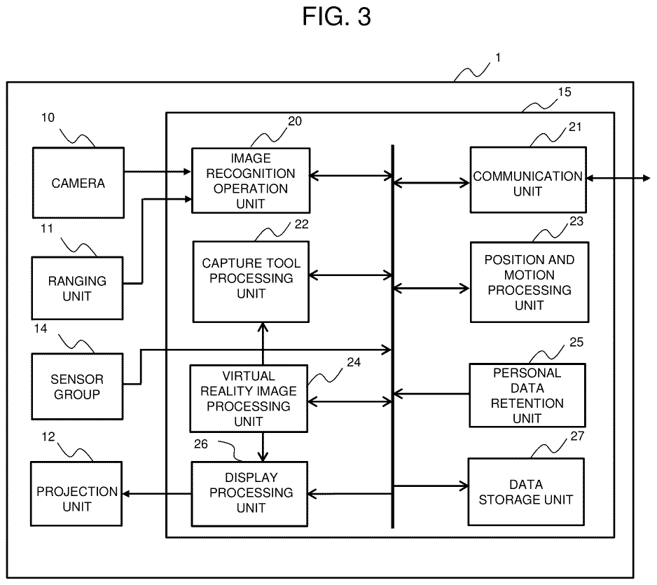

FIG. 3 is a functional block diagram of the HMD in this example, showing the details of the internal configuration of control unit 15. Identical reference numerals are assigned to the same functions as in FIG. 2. In addition, projection unit 12a and 12b in FIG. 2 are combined as projection unit 12. Microphones, speakers, screens, etc. are omitted.

In FIGS. 3, 20 is an image recognition operation unit, 21 is a communication unit, 22 is a capture tool processing unit, 23 is a position and motion processing unit, 24 is a virtual reality image processing unit, 25 is a personal data retention unit, 26 is a display processing unit, and 27 is a data storage unit.

The image recognition operation unit 20 receives camera images from the camera 10 and distance data from the ranging unit 11. It recognizes real objects such as the user's fingers and arms from the real world captured by the camera images, and assigns depth data to feature points of the real objects. Furthermore, it recognizes the intended operation of the user based on the movement of the user's fingers and hands.

The communication unit 21 downloads object data, etc. of the virtual space via the network, or reads object data, etc., that has already been stored from a storage device not shown in the figure.

The capture tool processing unit 22 provides the position, orientation, and angle of view for capturing, as if a drone or other device were operated in the real world to capture images with a camera from an arbitrary position, and generates a capture image to capture a part of the virtual space.

The position and motion processing unit 23 obtains the viewpoint from the position information and the line of sight from the orientation information based on the sensor signals of the GPS, orientation, and gyro sensors output by the position and motion sensors group 14.

The virtual reality image processing unit 24 generates display images from the background image of the background data of the virtual space and the avatar image of the object data, which can be obtained based on the viewpoint and line of sight.

The personal data retention unit 25 retains user information such as name and other details necessary for logging into the virtual reality service, as well as capture permission attributes and other similar data. The data storage unit 27 stores capture images.

The display processing unit 26 transmits the display images generated by the virtual reality image processing unit 24, or the capture image generated by the capture tool processing unit 22, to the projection unit 12.

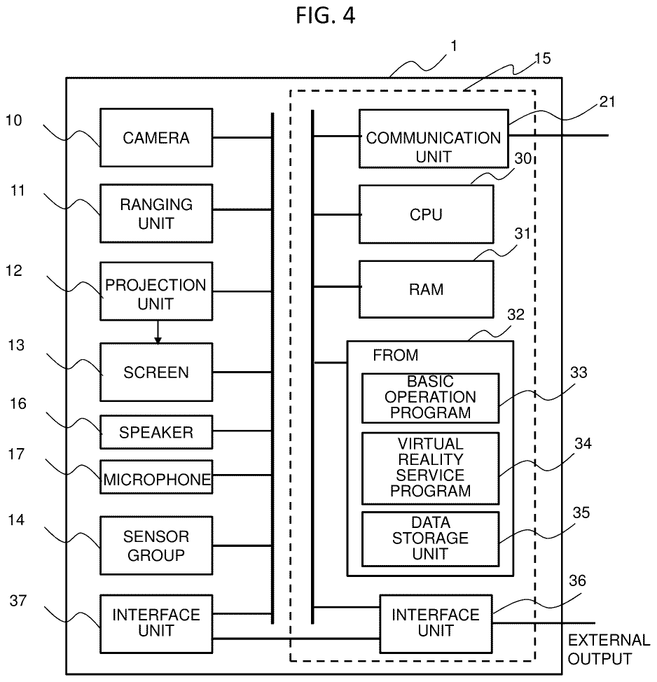

FIG. 4 shows a hardware block diagram of the HMD in this example. In FIG. 4, the same reference numerals are assigned to functions that are the same as those in FIGS. 2 and 3, and their descriptions are omitted. In FIG. 4, the difference from the functional block diagram in FIG. 3 is that control unit 15 is configured as an information processing device that executes various functions through software processing by interpreting an operation program by a CPU, etc. The advantage of using a general-purpose device such as a smartphone as the information processing device is available.

In FIG. 4, the control unit 15 includes a communication unit 21, a CPU 30, RAM 31, a flash ROM (FROM) 32, and an interface unit 36. The interface unit 36 is connected to interface unit 37 in the HMD main body and also handles external output.

The communication unit 21 of the control unit 15 connects the HMD 1 to the network by selecting an appropriate process from several communication processes such as 4G and 5G, and other mobile communication, wireless LAN, etc. Furthermore, object data and other data in the virtual space are downloaded from an external server. FROM 32 includes a basic program 33, a virtual reality service program 34, and a data storage unit 35 as processing programs. These processing programs are deployed in RAM 31 and executed by CPU 30. The data storage unit 35 temporarily stores intermediate data necessary for executing the processing programs and also serves as the personal data retention unit 25 and data storage unit 27 shown in FIG. 3. FROM 32 may be constituted as a single memory medium as shown in the figure, or as multiple memory media. Furthermore, it may be a non-volatile memory medium other than FLASH ROM.

The interface realized by interface units 36 and 37 may be wired, such as USB (registered trademark) and HDMI (registered trademark), or wireless, such as wireless LAN.

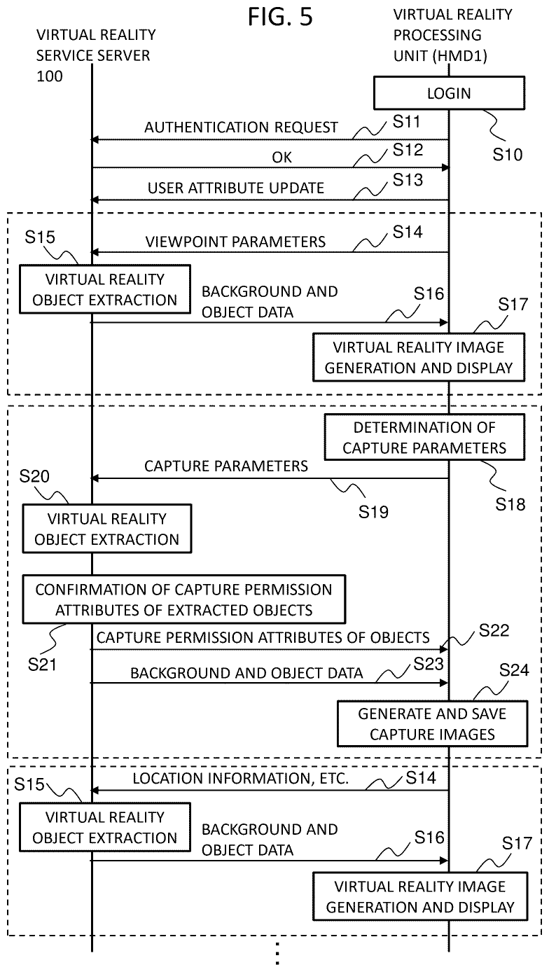

FIG. 5 shows the sequence diagram between the HMD and the virtual reality service server in this example. On the left side of the figure is the virtual reality service server 100, and on the right side is the virtual reality processing unit of HMD 1 (hereinafter sometimes referred to as HMD).

In FIG. 5, first, in step S10, the HMD 1 starts performing login. Then, in step S11, HMD 1 issues an authentication request to the server 100. The authentication request includes the user's ID, password (PW), and HMD 1 profile, etc. The user's ID and password (PW) are managed by the server 100 in association with the user's real name and the identity image for authentication. The profile of the HMD 1 is information on the capabilities of the hardware and software of HMD 1, for example, the ability to distinguish and handle display images and capture images of virtual reality, the ability to output display images externally, and so on.

Next, in step S12, if the user's ID and password sent from HMD 1 match the information registered on the server 100, HMD 1 is authenticated, and the server 100 issues an authentication OK confirmation.

Then, in step S13, HMD 1 issues a user attribute update. The user attributes include the capture permission attributes applied when the user is captured, and object data for display or capturing of the user, such as avatar images, and so on. The timing for issuing the update is not as shown in FIG. 5, but may be issued at any timing in the sequence. The server 100 uses the new user attributes after receiving the user attribute update.

Steps S14 to S17 are the sequence in which HMD 1 obtains display images in the virtual reality system. In step S14, HMD 1 transmits viewpoint parameters such as the user's position in the virtual space and the direction of gaze. In step S15, the server 100 extracts objects that exist within the range of visibility of the HMD 1 based on the received position and viewing direction. Furthermore, in step S16, the server 100 transmits background data and extracted object data. A wide range background data may be sent out in advance, and only data that complements the background data may be sent out in S16. In step S17, HMD 1 generates and displays a virtual reality display image using the received data.

Steps S18 through S24 are the sequence of capture. In step S18, the capture parameters such as the position, orientation, and angle of view of the capture location are determined by the capture tool of HMD 1 and transmitted to the server 100 in step S19.

In step S20, the server 100 extracts objects that exist within the capture range based on the received capture parameters. Furthermore, in step S21, the server 100 checks the capture permission attributes pertaining to the objects of other users among the extracted objects. In step S22, the server 100 transmits the capture permission attributes of the objects of other users. The capture permission attribute of another user's object refers to information indicating whether the other user permits capture, or information indicating whether they permit their identification during capture. This information is registered by other users as their own settings, and is recorded and managed by the server 100. In step S23, the server 100 transmits background and object data.

In step S24, HMD 1 generates and stores the capture image using the received capture permission attributes and background and object data of the other user's object. At this time, if the other user's capture permission attribute permits for identification during the generation of the capture image, an avatar image that can identify the person is obtained from the object data for capture. In this case, the image including the avatar that can identify the person is recorded as the capturing data during capturing. On the other hand, if the other user's capture permission attribute does not permit identification of the person, an avatar image in which the person is difficult to identify is obtained from the object data for capture, and the capture image is generated. In this case, the image including the avatar, whose identity is difficult to identify, is recorded as the capturing data during the capturing. Furthermore, if the other user's capture permission attribute does not permit capture, the avatar image is not used. In this case, an image that does not include the other user's avatar is recorded as the capturing data during the capturing.

Thereafter, the sequence from step S14 to S17, in which the HMD 1 obtains image for displaying virtual reality, and the capturing sequence from step S18 to S24, are repeatedly executed.

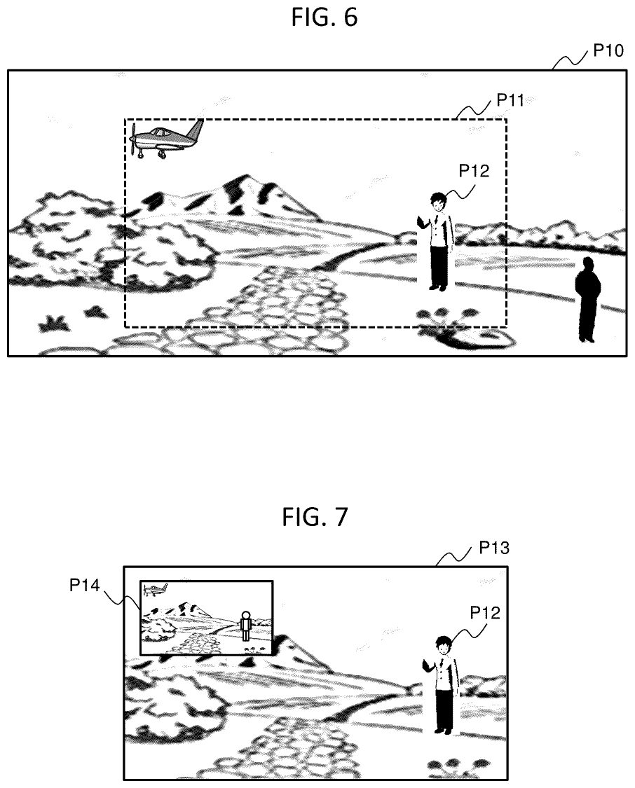

FIG. 6 illustrates the virtual space of the HMD and the user's field of view in this example. The user's field of view becomes the image for display in HMD 1.

In FIG. 6, the virtual space P10 is wider than the user's field of view P11. HMD 1 may receive the background data of the wide virtual space at once or divided into several times. The user's field of view P11 is determined by the user's position in the virtual space and viewing direction. If an avatar of another user exists in the user's field of view P11, the HMD 1 obtains an avatar P12 from the other user's object data for display and superimposes it onto the background of the virtual space in the field of view to generate an image for display. If no capture is performed by the HMD 1, the avatar P12 that can identify the person is displayed.

FIG. 7 is a diagram of an image for display of the HMD in this example, showing an example where the capture image P14 is superimposed on a part of display image P13. As a method of displaying the capture image to the user, in addition to the method of superimposing the capture image P14 on a part of the display image P13 as shown in FIG. 7, another method is to switch the image for display to the capture image for a certain period of time.

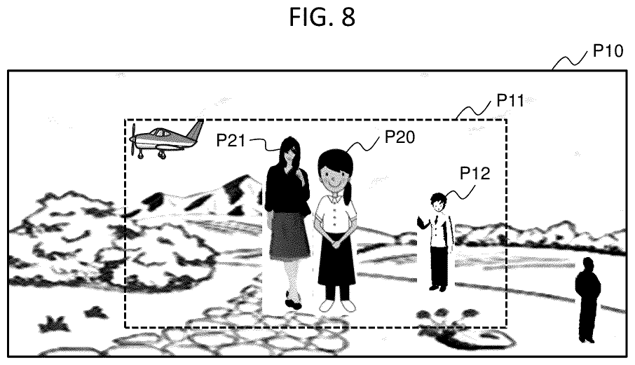

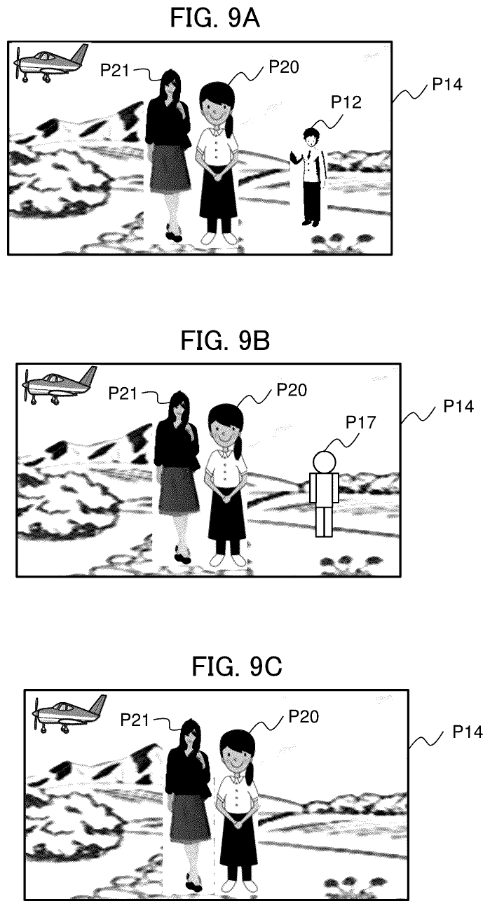

Next, the display when capturing with HMD 1 and the capture image will be explained using FIG. 8 and FIGS. 9A, 9B, 9C. FIG. 8 shows an example of the virtual space to be captured by the HMD in this example. In FIG. 8, the user's field of view P11 exists within the virtual space P10. Within the field of view P11, there are three avatars P12, P20, and P21 of other users.

FIGS. 9A, 9B, and 9C illustrate the capture images that are displayed and recorded by the HMD when capture is performed in the state shown in FIG. 8. It is assumed that the other users represented by the avatars P20 and P21 have permitted the use of object data for capture that permits for their identification. Next, the differences in the display according to the capture permission attribute of the other user represented by the avatar P12 are explained.

FIG. 9A is an example of the display when the user of the avatar P12 permits the use of the object data for capture that can identify the user. At this time, the capture image P14 uses the avatar P12 for display that can identify the person. FIG. 9B is an example of the display when the user of the avatar P12 does not permit the use of the object data for capture that can identify the user. At this time, the capture image P14 uses an avatar P17 for capture that makes it difficult to identify the person. FIG. 9C is an example of the display when the user of the avatar P12 does not permit capture. In this case, the avatar image of another user is not superimposed on the capture image P14.

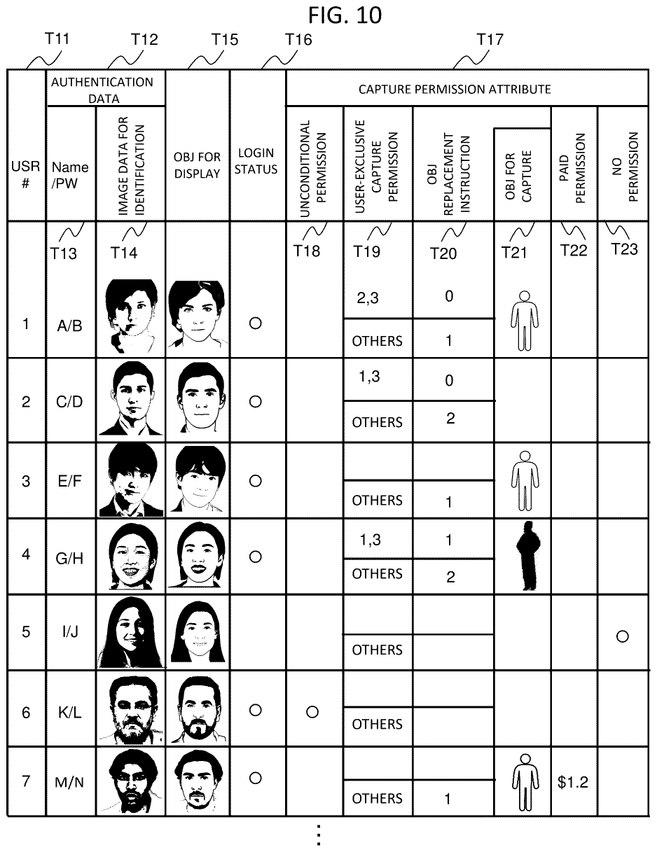

FIG. 10 shows the user attribute management table managed by the server 100 in this example. In FIG. 10, the attribute items of the user attribute management table are user management number (USR #) T11, authentication data T12, object data for display (abbreviated as OBJ for display in the figure) T15, login status T16, and the capture permission attribute T17.

Authentication data T12 includes name/password (Name/PW) T13 and image data for identification T14. The capture permission attribute T17 includes the following capture permission attribute items: unconditional permission T18, user-exclusive capture permission T19, object replacement instruction (abbreviated as OBJ replacement instruction in the figure) T20, object data for capture (abbreviated as OBJ for capture in the figure) T21, paid permission T22, and no permission T23.

The image data for identification T14, for example, encodes and registers a personal image equivalent to that on an identification document issued by a public institution. In FIG. 10, a personal image is shown as an example. The object data for display T15 is data capable of generating a highly detailed avatar image for display, sufficient to enable identification of each user, and is encoded as highly confidential data. FIG. 10 illustrates an example of an avatar's appearance. The login status T16 indicates that the virtual reality service is in use.

Three states are defined for the object replacement instruction T20. If the value of object replacement instruction T20 is 0, the object is not replaced and object data for display T15 is used for display. If the value of object replacement instruction T20 is 1, object data for capture T21 is used. If the value of object replacement instruction T20 is 2, the corresponding object is not displayed. The object data for capture T21 is used when the value of the object replacement instruction T20 is 1. It enables the generation of avatar capture image that makes it difficult to identify individual users. In FIG. 10, it is shown that a simple humanoid character is registered.

For example, regarding the user with user management number T11 set to 1, the username is A and the password is B. For the object capture permission attribute T17, user management numbers 2 and 3 are registered in the user-exclusive capture permission T19. In addition, the object replacement instruction T20 indicates that user management numbers 2 and 3 have the value 0, indicating that object replacement is not required, and the other users have the value 1, indicating that object replacement is required. Therefore, the object data for display T15 is used for the capture image only when the capture is performed by a user with user management numbers 2 or 3. In other words, if the user with user management numbers 2 or 3 performs the capture, an avatar recognizable as the user with management number 1 is recorded. For users other than those with management numbers 2 and 3, the value of the object replacement instruction is 1, and it is possible to perform the capture by replacing the object with the object data for capture T21. Therefore, if users other than those with management numbers 2 and 3 perform the capture, an avatar that makes it difficult to identify the user will be recorded.

The user with user management number T11 set to 2, whose username is C, does not require object replacement for users with user management numbers 1 and 3. Therefore, when a user with user management numbers 1 or 3 performs the capture, an avatar recognizable as the user with user management number 2 is recorded. For other users, since the value of the object replacement instruction T20 is 2, the corresponding object is not displayed. Therefore, if a user other than those with user management numbers 1 or 3 perform the capture, an avatar of the user with user management number 2 is not recorded.

The user with user management number T11 set to 3, whose username is E, does not have a user-exclusive capture permission setting and is permitted to be captured by replacing the object with the object data for capture T21. Therefore, no matter which user performs the capture, an avatar that makes it difficult to identify the user is recorded.

A user with user management number T11 set to 4, whose username is G, requires object replacement for users with user management numbers 1 and 3. Therefore, when a user with user management numbers 1 or 3 performs a capture, an avatar that makes it difficult to identify the user is recorded. For other users, the value of the object replacement instruction T20 is 2, so the corresponding object is not displayed. Therefore, if a user other than those with management numbers 1 and 3 performs the capture, the avatar of the user with user management number 4 is not recorded.

The user with user management number T11 set to 5, whose username is I, has set to no permission T23 in the capture permission attribute T17, and is not permitted to perform the capture. Therefore, no matter which user performs the capture, the avatar of the user with user management number 5 is not recorded.

The user with user management number T11 set to 6, whose username is K, has set to unconditional permission T18 in the capture permission attribute T17, which means that capture is unconditionally permitted. In other words, no matter which user performs the capture, an avatar that can be recognized as the user with user management number 6 is recorded.

The user with user management number T11 set to 7, whose username is M, has set to paid permission T22 in the capture permission attribute T17. In this case, if the user pays the $1.2 shown in FIG. 10, an avatar that can be recognized as the user with user management number 7 can be recorded. If there is no payment, the value of the object replacement instruction is 1, so it is possible to perform the capture by replacing the object with the object data for capture T21.

In FIG. 10, the capture permission/prohibition may be set at specific locations in the metaverse. In addition, the user-exclusive capture permission may be specified not only by user ID such as name, but also by relationship, e.g., friend registration. Furthermore, recording conditions may be linked to avatars using NFTs (Non-Fungible Tokens).

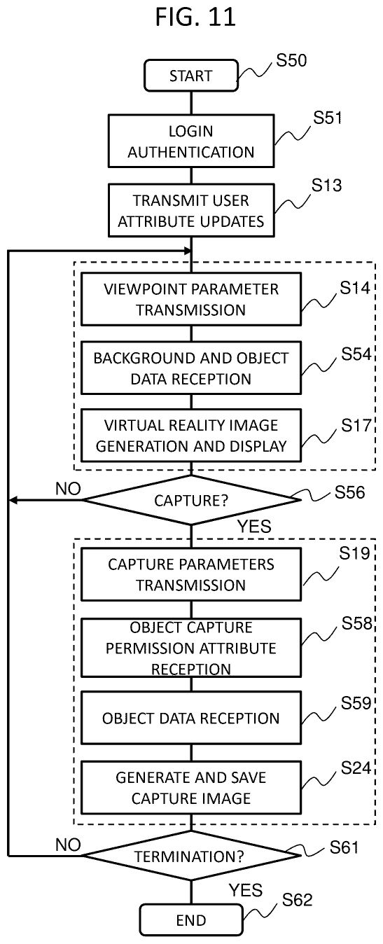

FIG. 11 is a flowchart of the virtual reality processing by the virtual reality service program 34 for the HMD in this example. In FIG. 11, the same processes as in FIG. 5 are assigned the same reference numerals, and their explanations are omitted.

In FIG. 11, the process is initiated at step S50, and login authentication is performed at step S51. In step S13, data for updating user attributes is sent to the server 100. Step S13 does not have to occur at this timing.

The viewpoint parameters are sent in step S14, and background and object data are received based on the location information in step S54. In step S17, an avatar image is calculated from the object data as a virtual reality image. If there are multiple object data, the avatar image is calculated for all object data. Furthermore, a display image is generated from the background image and avatar images and displayed. Steps S14 to S17 are the processes for generating the image for display.

At step S56, the HMD determines if the system is in a capture state. If not in a capture state (NO), the process returns to step S14, and the process to generate the display image is repeated. If the capture is performed (YES), capture parameters such as the capture position are transmitted in step S19. Then, in step S58, the HMD receives the capture permission attributes for the objects within the capture range based on the capture parameters. In step S59, it receives background and object data. The object data to be received is the object data for display when the capture permission attribute permits capturing, and the object data for capture when the capture permission attribute permits object replacement capturing. If the object data to be received has already been received in the processes to generate the display image, the object data reception may be skipped, and the temporarily stored object data may be used.

At step S24, the HMD calculates the avatar image from the object data. If there are multiple object data, avatar images are calculated for all object data. In addition, a capture image is generated from the background image and avatar image and saved. Steps S19 to S24 are the processes for generating the capture image.

At step S61, it is determined whether to continue the program. If continuing (YES), the process returns to step S14. If terminating (NO), the program ends at step S62.

As described above, the virtual reality system in this example includes an HMD implementing virtual reality processing, a virtual reality service server, and a network. When a user is wearing the HMD and experiencing virtual reality and wants to capture a part of the virtual space, the capture is executed using the capture tool of the virtual reality processing. At this time, the virtual reality processing of the HMD transmits the capture parameters to the virtual reality service server. When other users' objects are in the capture range, the virtual reality service server transmits the attributes pertaining to the capture permission of the other users' objects to the HMD. If there is no permission to capture, the HMD applies an avatar image, which makes personal information difficult to identify, to the other user's object to generate a capture image in the virtual space.

The HMD in this example includes a control unit that performs virtual reality processing, communication unit, position and other sensors, display unit, and image recognition operation unit. Additionally, it may also include a data storage unit and an external output unit. The communication unit is connected to the network and communicates with the virtual reality service server via the network. The communication unit transmits information from position and other sensors to the virtual reality service server, and receives from the virtual reality service server background data of the virtual space based on the user's current position and viewing direction, as well as object data of other user objects that exist within the user's field of view. The control unit generates display images of virtual reality using avatar images that can identify the user, and the display unit displays them. The image recognition operation unit may be composed of, for example, a camera unit and an image recognition unit. The camera unit, which captures the front of the HMD, captures the user's hand movements, which are then recognized by the image recognition unit to identify the user's operation. When the user wants to capture a part of the virtual space, capture tool of the control unit is used. The capture tool is similar to a drone capture in the real world. The user can perform the capture as if they are actually in the real world. For example, it is a snapshot with friends experiencing a virtual reality with the background provided by the virtual space. The captured images are stored in a data storage unit or output to an external device via an external output unit. At this time, other users' avatar images may appear in the background. The control unit informs the virtual reality service server of the capture parameters such as capture location, orientation, angle of view, etc. so that the virtual reality service server knows that it is in capture mode. The control unit obtains from the virtual reality service server the attributes related to the capture permission of other user objects that may appear within the capture range. If the user does not have permission to capture, the control unit generates a capture image by using an avatar image that is difficult for the user to identify, for example.

As explained above, this example enables a non-anonymous virtual reality system to provide a capture functionality in a virtual space that takes user privacy protection into consideration.

### Example 2

This example describes a case in which the HMD does not have the ability to separately handle display images and capture images of virtual reality, or where it involves external output of display images. The configuration of HMD 1 shown in FIG. 2, FIG. 3, and FIG. 4 is also applicable to this example.

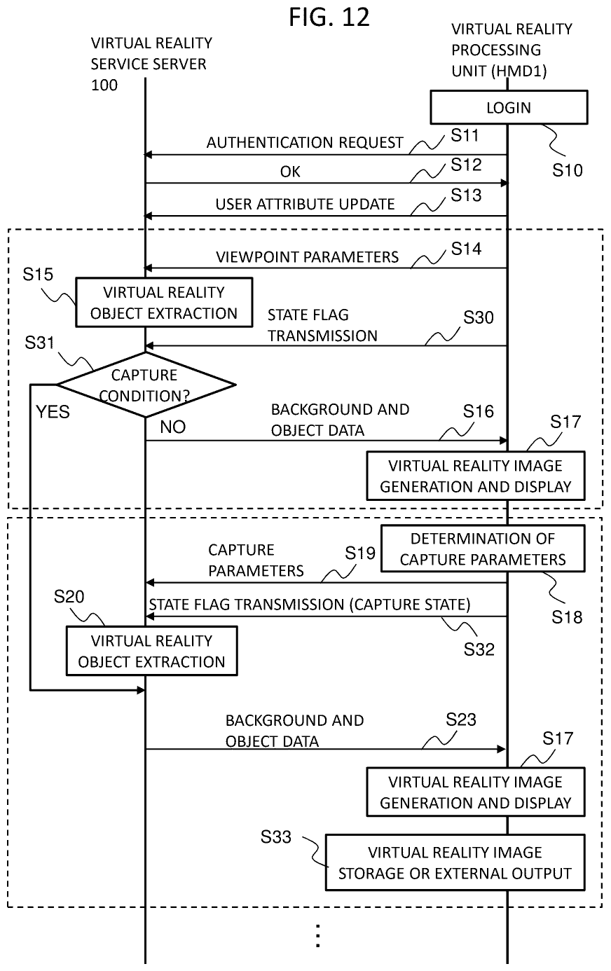

FIG. 12 shows a sequence diagram between the HMD and the virtual reality service server in this example. In FIG. 12, elements identical to those in FIG. 5 are denoted by the same reference numerals, and redundant explanations are omitted.

In FIG. 12, steps S14 to S17 are the sequence for HMD 1 to obtain display images in the virtual reality system, as in FIG. 5 of Example 1. HMD 1 transmits a state flag to the server 100 in step S30 after the login process. The state flag is a capture notification information indicating whether the HMD 1 is in a non-capture state or a capture state. Normally, HMD 1 transmits a value indicating a non-capture state immediately after user login, since the user has not started capturing. If the HMD 1 does not have the ability to distinguish between display images and capture images in virtual reality, or if the HMD 1 does not have the ability to stop the external output of display images, it is recommended to transmit a value indicating the capture state.

The server 100 determines the capture state of the HMD 1 using the state flag in step S31. If the state flag received by the server 100 is a value indicating a non-capture state, the background and object data of the virtual reality objects is sent to the HMD 1 in step S16. In this case, HMD 1 generates and displays a display image of virtual reality using the object data received in step S17. The object data sent from the server 100 in step S16 is the normal object data for display, which is not intended to be captured, and a display avatar is displayed in step S17. This is the process when the state flag is sent indicating a non-capture state in step S30.

On the other hand, if HMD 1 transmits a value indicating the capture state in the state flag in step S30, the server 100 determines that the state flag indicates the capture state in step S31. In this case, the server 100 skips steps S16 through S20 and proceeds to step S23.

In HMD 1, steps S18 through S33 are the sequence of capturing. The capture parameters of HMD 1 are determined in step S18, and the capture parameters are transmitted to the server 100 in step S19. In addition, the state flag of HMD 1 is sent to the server 100 in step S32. The state flag is a value indicating the capture state.

In step S20, when the server 100 receives the capture parameters and the state flag, a value indicating the capture state, it extracts objects that exist within the capture range based on the capture parameters. It is also possible for the server 100 to process step S20 without the HMD 1 explicitly transmitting the state flag, but based on the transmission and reception of the capture parameters, the server 100 considers it to be in the capture state.

The server 100 then transmits the extracted background and object data in step S23. The HMD 1 generates and displays the virtual reality image as a capture image in step S17, and further saves H externally outputs the virtual reality image as a capture image in step S33.

If the transmission of the state flag in step S30 is not confirmed, the server 100 treats the HMD 1 as being in the capture state and processes accordingly. In other words, it selects the object data to be sent to HMD 1 according to the capture permission attribute T17 in FIG. 10. Therefore, unless unconditional permission T18 is set, the object data for display T15 of other users in the virtual space is not sent to HMD 1, ensuring the protection of user privacy. For external output, since the capabilities of the connected external device are unknown, the protection of other users' privacy follows the same standards as for capture images.

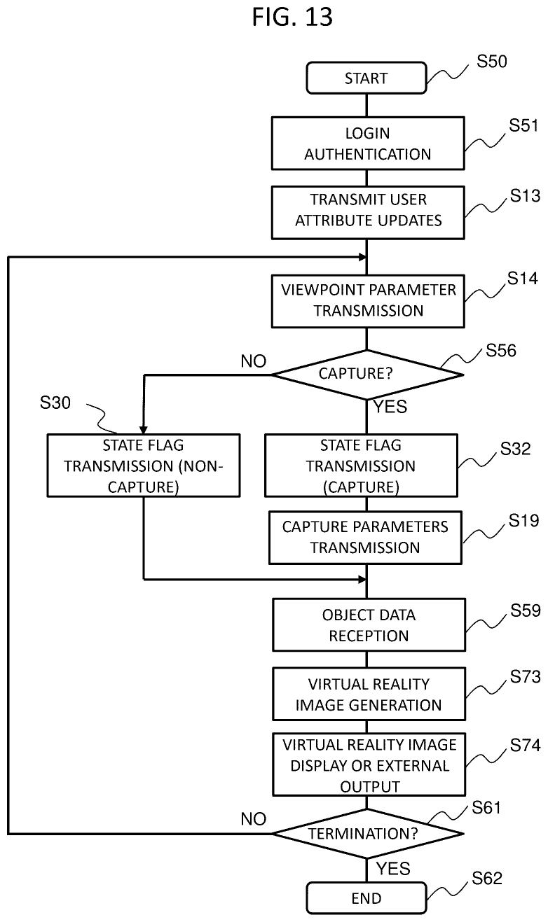

FIG. 13 is a flowchart of the virtual reality processing of the virtual reality service program 34 of the HMD in this example. In FIG. 13, the same steps as in FIG. 11 are assigned the same reference numerals, and redundant explanations are omitted.

In FIG. 13, the capture state is determined at step S56, and if the HMD is in the capture state, it transmits a value indicating the capture state using a state flag at step S32 and then transmits capture parameters, such as capture location, at step S19. If the capture state is determined to be non-capture state at step S56, the HMD transmits a value indicating the non-capture state in step S30. Then, the HMD receives object data at step S59. The object data to be received in step S59 is transmitted from the server 100 based on the state flag transmitted in step S32 or S30. For example, if the capture permission attribute permits capturing, it is the object data for display to generate an avatar image for display in which the person can be identified. If the object replacement capturing is permitted in the capture permission attribute, it is the object data for capture to generate an avatar image for capture in which the person cannot be identified.

The avatar image is generated from the object data in step S73. The generated virtual reality image becomes a display image to be displayed in step S74, a capture image, and an external output image to be displayed or output externally.

As explained above, according to this example, in a non-anonymous virtual reality system, even when the HMD does not have the ability to distinguish and handle display images and capture images in virtual reality, or when display images are output externally, transmitting a state flag in advance enables the provision of a capture functionality in the virtual space that considers user privacy protection. In addition, as long as the server does not receive the state flag, the avatar display will be in accordance with the capture permission attributes of other users' objects, thus ensuring the protection of privacy.

### Example 3

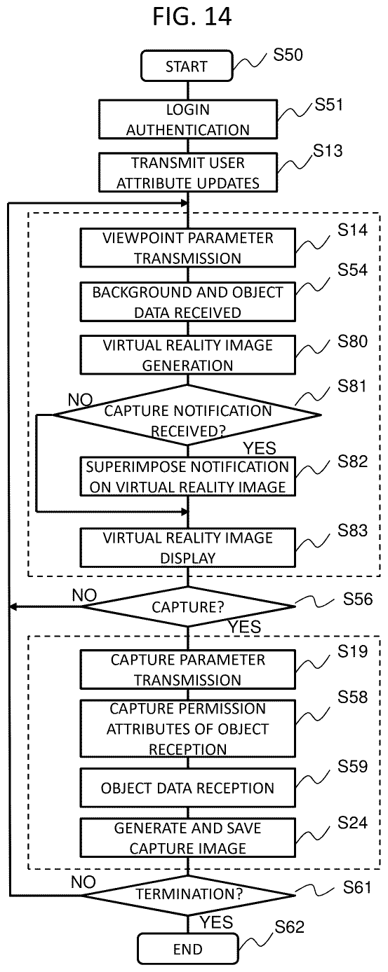

FIG. 14 is a flowchart of the virtual reality processing of the virtual reality service program 34 of the HMD in this example. The configuration of HMD 1 in FIG. 2, FIG. 3, and FIG. 4 is also applied in this example. In FIG. 14, the same steps as in FIG. 11 are assigned the same reference numerals, and redundant explanations are omitted.

In FIG. 14, the display image generation step S17 in FIG. 11 is replaced with steps S80 to S83. In step S80, a virtual reality image is generated. Before displaying the generated virtual reality image as a display image in step S83, it is confirmed in step S81 whether there is a notification indicating that the user is being captured. In step S81, if it is determined that the user is being captured (YES), a notification mark indicating the captured state is superimposed on the virtual reality image in step S82. The notification mark can be a colored marker, such as red, to make the user aware that the user is being captured. The virtual reality image with the notification mark superimposed is displayed as a display image in step S83.

Notification methods other than notification marks may also be used. For example, since the user's avatar's hand is visible to the user, the avatar's hand may be changed to a display different from usual. Examples of such changes include making the visible part of the hand glow, changing its color, or rendering it semi-transparent.

As explained above, according to this example, in the HMD of a non-anonymous virtual reality system, it is possible to provide a capture functionality in a virtual space that takes user privacy protection into consideration. Furthermore, it has the advantage that users being captured can easily recognize that they are being captured, similar to in the real world.

As explained above, the present invention is not limited to the above-described examples, and various modifications may be included. For example, in the above examples, it is described a CPU or the like interprets an operation program and executes various functions through software processing. However, part or all of the above configurations may be implemented in hardware, or hardware and software may be used together. The above examples are described in detail for the purpose of explaining the invention in an easy-to-understand manner, and are not necessarily limited to all of the configurations described. It is also possible to replace a part of the configuration of one example with the configuration of another example, and it is also possible to add the configuration of another example to the configuration of one example. It is also possible to add, delete, or replace some of the configurations of each example with other configurations.

### Reference Signs List

1: head mounted display (HMD), 1A: user, 100: virtual reality service server (server), 200: network, 300: access point, P10: virtual space, P11: field of view, P12, P17, P20, P21: avatar, P13: display image, P14: capture image, T11: User attribute data, T12: authentication data, T15: object data for display, T17: capture permission attribute, T21: object data for capture, 10: camera, 11: ranging unit, 12, 12a, 12b: projection unit, 13: screen, 14: sensor group, 15: control unit, 20: image recognition operation unit, 21: communication unit, 22: capture tool processing unit, 23: position and motion processing unit, 24: virtual reality image processing unit, 25: personal data retention unit, 26: display processing unit, 27: data storage unit, 30: CPU, 32: FROM, 34: virtual reality service program, 35: data storage unit, 36: interface unit.

1. A virtual reality system comprising a server that provides virtual reality services, a head mounted display that receives the virtual reality services, and a network that connects the server and the head mounted display, wherein
the server retains first object data for generating a first avatar image for display, second object data for generating a second avatar image for capture, and a capture permission attribute for setting capture conditions when a user is captured by an other user as user information,
the server transmits the first object data or the second object data to the head-mounted display according to the capture permission attribute,
the head-mounted display generates and displays the first avatar image or the second avatar image from the received first object data or second object data.

2. The virtual reality system according to claim 1, wherein
the server transmits the first object data for generating the first avatar image for display as object data for display to the head-mounted display if the capture permission attribute permits identification of the user, and transmits the second object data for generating the second avatar image for capture as object data for capture to the head-mounted display if the capture permission attribute does not permit identification of the user.

3. The virtual reality system according to claim 2, wherein
the head-mounted display transmits, when capturing of a virtual space, capture information including a viewpoint parameter such as a position and gaze direction of the user in a virtual reality space, or a capture parameter such as a position, orientation, and angle of view of a capture location in the virtual reality space, to the server, and
the server recognizes an other user presents in a capture range based on the capture information and transmits the object data for display or the object data for capture to the head-mounted display in accordance with the capture permission attribute of the other user.

4. The virtual reality system according to claim 3, wherein
the server obtains capability information of the head mounted display, recognizes an other user presents within a field of view, and transmits the object data for display or the object data for capture of the other user to the head-mounted display in accordance with the capability information and the capture permission attribute of the other user.

5. The virtual reality system according to claim 4, wherein
the capability information is information regarding an ability to generate a display image and a capture image separately, or an ability to output a display image externally.

6. The virtual reality system according to claim 2, wherein
the head-mounted display transmits capture notification information indicating whether a virtual space is being captured to the server, and
the server transmits the object data for display or the object data for capture to the head-mounted display in accordance with the capture notification information and the capture permission attribute of an other user.

7. The virtual reality system according to claim 6, wherein
the server, when unable to receive the capture notification information, transmits the object data for capture to the head-mounted display.

8. The virtual reality system according to claim 1, wherein
the first avatar image for display is an avatar image that can identify the user, and
the second avatar image for capture is an avatar image that is difficult to identify the user.

9. A head mounted display that communicates with a server that provides virtual reality services, comprising:
a control unit that executes virtual reality processing, a communication unit, and a display unit, wherein
the communication unit receives, from the server, a first object data or a second object data according to a capture permission attribute setting capture conditions when a user is captured by an other user, and
the control unit generates a first avatar image for display or a second avatar image for capture using the received first or second object data, and displays the image on the display unit.

10. The head-mounted display according to claim 9, wherein
the first object data is object data for display that generates the first avatar image for display when the capture permission attribute permits identification of the user, and the second object data is object data for capture that generates the second avatar image for capture when the capture permission attribute does not permit identification of the user.

11. The head-mounted display according to claim 10, wherein
the control unit transmits, via the communication unit, capture information including a viewpoint parameter such as a user's position and gaze direction in a virtual reality space, or a capture parameter such as a position, orientation, and angle of view of a capture location in the virtual reality space, when capturing a virtual space.

12. The head-mounted display according to claim 11, wherein
the control unit transmits, via the communication unit, capability information of the head-mounted display to the server, and
the control unit receives, from the server, the object data for display or the object data for capture of the other user, in accordance with the capture permission attribute of the other user within a field of view based on the capability information and the viewpoint parameter.

13. The head-mounted display according to claim 12, wherein
the capability information is information about an ability to generate a display image and a capture image separately, or an ability to output a display image externally.

14. The head-mounted display according to claim 10, wherein
the control unit transmits, via the communication unit, capture notification information indicating whether a virtual space is being captured to the server, and
the control unit receives the object data for display or the object data for capture of an other user in accordance with the capture notification information.

15. The head-mounted display according to claim 9, comprising:
a data storage unit that stores a user attribute comprising personal data and image data, wherein
the personal data includes authentication data and the capture permission attribute,
the capture permission attribute includes capture permission information and conditional capture permission information,
the image data includes object data for display and object data for capture used in conditional capture, and
the control unit transmits the user attribute to the server via the communication unit.

16. The head-mounted display according to claim 10, wherein
a display indicating a capture state is provided in a display image when the user is being captured.

17. The head-mounted display according to claim 9, wherein
the first avatar image for display is an avatar image that can identify the user, and
the second avatar image for capture is an avatar image that is difficult to identify the user.
